(19) United States
(12) Patent Application Publication
(10) Pub. No.: US 2016/0318133 A1
(43) Pub. Date: Nov. 3, 2016

(54) WELDING MATERIAL FOR HEAT RESISTANT STEEL

(71) Applicant: POSCO, Pohang-si (KR)

(72) Inventors: Il-Wook HAN, Pohang-si (KR); Jeong-Kil KIM, Pohang-si (KR); Bong-Keun LEE, Pohang-si (KR); Sang-Chul LEE, Pohang-si (KR)

(73) Assignee: POSCO, Phohang-si (KR)

(21) Appl. No.: 15/107,633

(22) PCT Filed: Dec. 24, 2013
(86) PCT No.: PCT/KR2013/012148

§ 371 Date: Jun. 23, 2016

(30) Foreign Application Priority Data
Dec. 24, 2013 (KR) 10-2013-0163190

(51) Int. Cl. B23K 35/36; C22C 38/58; C22C 38/50; C22C 38/00; C22C 38/42; C22C 38/06; C22C 38/04; C22C 38/02; B23K 35/30; C22C 38/44

(52) U.S. Cl. CPC B23K 35/3601; B23K 35/3066; B23K 35/3086; B23K 35/3033; B23K 35/304; C22C 38/58; C22C 38/50; C22C 38/44; C22C 38/42; C22C 38/06; C22C 38/04; C22C 38/02; C22C 38/002

(57) ABSTRACT

A welding material for heat resistant steel comprises: flux and a sheath surrounding the flux. The welding material comprises, by wt %, carbon (C): 0.03% to 0.3%, manganese (Mn): 0.5% to 3.0%, silicon (Si): 0.1% to 2.0%, phosphorus (P): 0.01% or less, sulfur (S): 0.01% or less, nickel (Ni): 20% to 40%, chromium (Cr): 15% to 35%, TiO₂: 3% to 7%, SiO₂: 0.5% to 2.5%, ZrO₂: 0.5% to 2.5%, and a balance of Fe and inevitable impurities. The sheath comprises an Ni—Fe-based alloy having a nickel content of 30% to 50%.

### TECHNICAL FIELD

The present disclosure relates to a welding material, and more particularly, to a welding material for heat resistant steels for high-temperature applications.

### BACKGROUND ART

Heat resistant steels used for high-temperature applications such as nuclear reactors, power plant tubes, blast furnaces, fluidized bed furnaces, or annealing furnaces are required to have high-temperature strength and crack resistance. Such heat resistant steels may be used to manufacture structures through welding processes, and weld zones of such structures are also required to have high-temperature strength and crack resistance.

For example, austenitic stainless steels or Ni-based or Co-based ultra heat resistant alloys have been used as heat resistant steels. However, both steel sheets and welding materials based on Ni-based or Co-based ultra heat resistant alloys are expensive, due to high contents of relatively expensive alloying elements, and since gas tungsten arc welding (GTAW) is used, weldability and productivity are poor. Therefore, the application of Ni-based or Co-based ultra heat resistant alloys is very limited. On the other hand, austenitic stainless steels are processable through any kind of welding having a high degree of productivity such as flux-cored arc welding (FCAW) by taking economic aspects and weldability into consideration. In addition, austenitic stainless steels are relatively inexpensive. Thus, the use of austenitic stainless steel has increased since 1980s.

Particularly, among austenitic stainless steels (STS 300-series steels), fully austenitic stainless steels having relatively high degrees of high-temperature corrosion resistance, high-temperature strength, and ductility have been mainly used for applications in high-temperature, highly corrosive work environments such as nuclear reactors, power plant tubes, blast furnaces, fluidized bed furnaces, or annealing furnaces. Fully austenitic stainless welding materials (STS 310-series welding materials) have been used for such fully austenitic stainless steels.

However, cracks are easily formed in the weld zones of STS 310-series welding materials. Like base metals, STS 310-series welding materials having a fully austenitic solidification structure formed through single-phase solidification have high contents of nickel (Ni) and chromium (Cr) and a high degree of thermal expansion. However, it is known that since the solubility of phosphorus (P) and sulfur (S) in weld zones formed using STS 310-series welding materials is high, 5-ferrite effective in reducing high-temperature cracking is not formed in the weld zones, and as the weld zones undergo single-phase solidification, high-temperature cracking easily occurs.

In a welding process using an austenitic welding material, phosphorus (P) or sulfur (S) forms a low melting point eutectic compound such as Fe₃P or FeS which segregates along grain boundaries and exists in a liquid state during solidification, thereby facilitating high-temperature cracking. The content of phosphorus (P) and sulfur (S) in currently commercially available STS 310-series welding materials is high, within the range of about 200 ppm to 300 ppm, because of manufacturing methods and composition characteristics of the STS 310-series welding materials. STS 310-series welding materials widely used for STS 300-series heat resistant steels being typical heat resistant materials are fully austenitic materials having no 5-ferrite, and during a welding process using such a STS 310-series welding material, phosphorus (P) and sulfur (S) included in the base metal and welding metal segregate along grain boundaries of the welding metal, thereby causing cracks.

To address these problems, a flux-cored welding material including a sheath formed of an STS 300-series steel such as STS 304L or 316L and flux present in the sheath has been proposed (Patent Document 1). In detail, referring to Patent Document 1, the sheath is formed of a STS 300-series stainless steel, and components such as a rare earth metal (REM) or calcium (Ca) are added to the flux, so as to suppress the formation of cracks caused by phosphorus (P) and sulfur (S). However, the welding material disclosed in Patent Document 1 also has high contents of phosphorus (P) and sulfur (S), and thus, the formation of cracks in a weld zone may not be fully prevented.

Therefore, the development of a welding material capable of suppressing the formation of cracks in a weld zone of heat resistant steel is needed.

(Patent Document 1) Korean Patent No. 1118904

### DISCLOSURE

### Technical Problem

An aspect of the present disclosure may provide a welding material capable of suppressing the formation of cracks in a weld zone of heat resistant steel.

### Technical Solution

According to an aspect of the present disclosure, a welding material for heat resistant steel may include flux and a sheath surrounding the flux,

wherein the welding material may include, by wt %, carbon (C): 0.03% to 0.3%, manganese (Mn): 0.5% to 3.0%, silicon (Si): 0.1% to 2.0%, phosphorus (P): 0.01% or less, sulfur (S): 0.01% or less, nickel (Ni): 20% to 40%, chromium (Cr): 15% to 35%, TiO₂: 3% to 7%, SiO₂: 0.5% to 2.5%, ZrO₂: 0.5% to 2.5%, and a balance of Fe and inevitable impurities,

wherein the sheath may include a Ni—Fe-based alloy having a nickel content of 30% to 50%.

### Advantageous Effects

The welding material of the present disclosure may suppress the formation cracks in the weld zones of heat resistant steels for high-temperature applications such as blast furnaces, fluidized bed furnaces, nuclear reactors, or power plants. Therefore, the welding material may be safely used in various applications.

In addition, since weld zones formed using the welding material of the present disclosure have a fully austenitic microstructure having a high degree of low-temperature toughness, the welding material may be used to form crack-free weld zones for liquefied natural gas (LNG) tanks having cryogenic properties. That is, the welding material of the present disclosure may also be used to manufacture structures of thick austenitic steel sheets in various fields such as oil refining, pipe work, construction, shipbuilding, or maritime engineering.

### BEST MODE

Hereinafter, a welding material will be described in detail with reference to the accompanying drawings. The drawings are attached hereto to help explain exemplary embodiments of the invention, and the present invention is not limited to the drawings and embodiments. In the drawings, some elements may be exaggerated, reduced in size, or omitted for clarity or conciseness. According to an exemplary embodiment of the present disclosure, the welding material is a flux cored welding material including flux and a sheath surrounding the flux.

The welding material of the exemplary embodiment includes carbon (C): 0.03% to 0.3%, manganese (Mn): 0.5% to 3.0%, silicon (Si): 0.1% to 2.0%, phosphorus (P): 0.01% or less, sulfur (S): 0.01% or less, nickel (Ni): 20% to 40%, chromium (Cr): 15% to 35%, TiO₂: 3% to 7%, SiO₂: 0.5% to 2.5%, and ZrO₂: 0.5% to 2.5%, based on the total weight of the welding material including the flux and the sheath.

Carbon (C) promotes the formation of austenite and improves strength. If the content of carbon (C) is less than 0.03%, it is difficult to guarantee high-temperature strength. Conversely, if the content of carbon (C) is greater than 0.3%, eutectic mixtures are excessively formed during welding, thereby leading to high-temperature cracking and the formation of welding fumes and spatters. Therefore, it may be preferable that the content of carbon (C) be within the range of 0.03% to 0.3%.

During welding, manganese (Mn) reacts with oxygen (O) and sulfur (S), thereby removing oxygen (O) and sulfur (S). Thus, manganese (Mn) is added in an amount of 0.5% or greater. However, if manganese (Mn) is added in an amount of greater than 3%, the fluidity of molten metal decreases, thereby decreasing weld penetration and arc stability. Therefore, it may be preferable that the content of manganese (Mn) be within the range of 0.5% to 3.0%.

Preferably, Silicon (Si) may be added in an amount of 0.1% or greater so as to maximize deoxidation, together with manganese (Mn), during welding. However, if silicon (Si) is added in an amount greater than 2.0%, crack resistance decreases due to excessive formation of eutectic mixtures. Therefore, it may be preferable that the content of manganese (Mn) be within the range of 0.1% to 2.0%.

Even small amounts of phosphorus (P) and sulfur (S) facilitate the formation of low melting point compounds, thereby decreasing the melting point of the welding material and increasing the high-temperature crack sensitivity of the welding material. Thus, the contents of phosphorus (P) and sulfur (S) are adjusted to be as low as possible. Although phosphorus (P) and sulfur (S) are inevitably included, it is preferable that each of the contents of phosphorus (P) and sulfur (S) be less than 0.01%.

Nickel (Ni) is an austenite forming element preferably added in an amount of 20% or greater so as to promote the formation of a fully austenitic microstructure and guarantee resistance to high-temperature oxidation, high-temperature strength, and ductility. However, if the content of nickel (Ni) is greater than 40%, the viscosity of a weld zone increases excessively, causing the formation of pores and insufficient weld penetration. Therefore, preferably, the content of nickel (Ni) is adjusted to be 40% or less.

Although chromium (Cr) is a ferrite forming element, it is preferable that the content of chromium (Cr) is 15% or greater. However, if the content of chromium (Cr) is greater than 35%, ductility decreases because of the formation of ferrite and chromium carbides at high temperature. Therefore, it may be preferable that the content of chromium (Cr) be within the range of 15% to 35%.

TiO₂ stabilizes arcs and forms slag. If the content of TiO₂ is less than 3%, unstable arcs are formed. Particularly, slag is formed when TiO₂ is present in amounts which are too small. In this case, a welding metal may not be completely covered with slag, and rough weld beads may be formed. However, if the content of TiO₂ is greater than 7%, there is a limit to adding alloying elements to the inside of a sheath strip, and slag may be excessively formed. Therefore, it may be preferable that the content of TiO₂ be within the range of 3% to 7%.

SiO₂ increases the viscosity of slag. If the content of SiO₂ is less than 0.5%, the viscosity increasing effect is insufficient, and if the content of SiO₂ is greater than 2.5%, the viscosity increasing effect is excessive, causing defects such as residual inclusions. Therefore, it may be preferable that the content of SiO₂ be within the range of 0.5% to 2.5%.

ZrO₂ has a high melting point and thus increases the melting point of slag. Thus, it may be preferable that the content of ZrO₂ be within the range of 0.5% or greater. However, if the content of ZrO₂ is greater than 2.5%, non-molten sparks are generated around an arc. Therefore, it may be preferable that the content of ZrO₂ be within the range of 0.5% to 2.5%.

Preferably, the total content of phosphorus (P) and sulfur (S) in the welding material may be adjusted to be 0.012% or less. Since the crack sensitivity of a weld zone increases during solidification as the total contents of phosphorus (P) and sulfur (S) increase, it is preferable to reduce the total content of phosphorus (P) and sulfur (S). That is, when the composition of a base metal and the mixing of the base metal and the welding material are considered, it may be preferable that the total content of phosphorus (P) and sulfur (S) be within the range of 0.012% or less.

In addition, the welding material of the exemplary embodiment may further include at least one selected from the group consisting of molybdenum (Mo): 2.0% or less, copper (Cu): 1.0% or less, aluminum (Al): 0.5% or less, and magnesium (Mg): 0.5% or less.

Molybdenum (Mo) may be added to increase high-temperature strength and oxidation resistance. However, if the content of molybdenum (Mo) is greater than 2.0%, ductility may decrease. Therefore, it may be preferable that the content of molybdenum (Mo) be within the range of 2.0% or less.

Copper (Cu) may be added in an amount of 1.0% or less in order to improve oxidation resistance.

Aluminum (Al) and magnesium (Mg) may be added for the deoxidation, desulfurization, and microstructure refinement of a welding metal. However, if the respective contents of aluminum (Al) and magnesium (Mg) are greater than 0.5%, the surface tension of the welding metal may increase, and thus spatters may be excessively formed. Therefore, it may be preferable that each of the contents of aluminum (Al) and magnesium (Mg) be within the range of 0.5% or less.

In addition, the welding material of the exemplary embodiment may further include at least one selected from the group consisting of titanium (Ti): 0.5% or less, fluorine (F): 0.5% or less, Na₂O: 0.25% or less, K₂O: 0.3% or less, Al₂O₃: 0.5% or less, MnO: 0.5% or less, and MgO: 0.5% or less.

Titanium (Ti) may be added to ensure arc stability and prevent grain boundary corrosion. However, if the content of titanium (Ti) is greater than 0.5%, carbides or nitrides are formed in a weld zone, and thus ductility may decrease. Therefore, it may be preferable that the content of titanium (Ti) be within the range of 0.5% or less.

Fluorine (F) may be added to improve the spreadability of weld slag. However, if fluorine (F) is excessively added in an amount greater than 0.5%, the viscosity of slag may be too low, and thus the shape of weld beads may be worsened. Therefore, it may be preferable that the content of fluorine (F) be within the range of 0.5% or less.

Na₂O and K₂O are alkali oxides likely to undergo ionization and have an effect of improving the fluidity of slag. However, if the content of Na₂O is greater than 0.25% and the content of K₂O is greater than 0.3%, welding fumes may be excessively generated.

Al₂O₃, MnO, and MgO may be added to control the viscosity of slag and thus to promote the formation of high-quality weld beads and protect a weld pool. However, it may be preferable that each of the contents of Al₂O₃, MnO, and MgO be within the range of 0.5% or less.

Hereinafter, the sheath of the welding material of the exemplary embodiment will be described in detail.

Preferably, the sheath may be formed of an Ni—Fe-based alloy including nickel (Ni) in an amount of 30% to 50%. According to the exemplary embodiment, so as to provide a welding material for high alloy stainless steel having high corrosion resistance, high-temperature corrosion resistance, high-temperature strength, high ductility, and high-temperature crack resistance, the sheath may be formed of a high alloy sheath material such as an Ni—Fe-based alloy having very low contents of phosphorus (P) and sulfur (S) and a high content of nickel (Ni) which is a heat-resistant alloying element.

Since the sheath has a high nickel content, the content of chromium (Cr) may be reduced to decrease the solubility of phosphorus (P) in the sheath, and thus the content of phosphorus (P) in a weld zone may be minimized. In addition, since the sheath does not have factors such as chromium compounds promoting precipitation strengthening, the sheath may have high degrees of malleability, ductility, and workability. That is, a high nickel welding material for heat resistant steel may be provided.

In the exemplary embodiment, the Ni—Fe-based alloy may be a 36% Ni—Fe invar alloy.

Hereinafter, the flux of the welding material of the exemplary embodiment will be described in detail.

The flux includes carbon (C): 0.1% to 2.0%, manganese (Mn): 2.0% to 10.0%, silicon (Si): 0.5% to 8.0%, phosphorus (P): 0.01% or less, sulfur (S): 0.01% or less, chromium (Cr): 40% to 80%, molybdenum (Mo): 0.1% to 8.0%, TiO₂: 7% to 25%, SiO₂: 2% to 10%, and ZrO₂: 1% to 10%, based on the weight of the flux.

Carbon (C) is an element stabilizing austenite and improving strength. However, if the content of carbon (C) is less than 0.1%, heat-resistant high-temperature strength may not be guaranteed. Conversely, if the content of carbon (C) is greater than 2.0%, fumes and spatters may be excessively generated during welding. Therefore, it may be preferable that the content of carbon (C) be within the range of 0.1% to 2.0%.

During welding, manganese (Mn) reacts with oxygen (O) and sulfur (S) and forms slag as a product of deoxidation and desulfurization reactions. Due to this, the content of manganese (Mn) decreases. In the regard, manganese (Mn) is added in an amount of 2.0% or greater. However, if the content of manganese (Mn) is greater than 10.0%, the generation of fumes increases, and the fluidity of molten metal markedly decreases. Therefore, it may be preferable that the content of manganese (Mn) be within the range of 2.0% to 10.0%.

During welding, silicon (Si) functions as a deoxidizer together with manganese (Mn) and forms slag. By considering this, it may be preferable that the content of silicon (Si) be within the range of 0.5% or greater. However, if the content of silicon (Si) is greater than 8%, crack resistance decreases. Thus, it is preferable that the content of silicon (Si) be 8% or less.

Phosphorus (P) and sulfur (S) are impurities in the flux, and the contents of phosphorus (P) and sulfur (S) are each controlled to be 0.01% or less based on the weight of the flux. If the contents of phosphorus (P) and sulfur (S) are each greater than 0.01%, high-temperature crack sensitivity increases because phosphorus (P) and sulfur (S) in the flux are mixed with phosphorus (P) and sulfur (S) diffused from the sheath and a base metal. Therefore, preferably, each of the contents of phosphorus (P) and sulfur (S) is adjusted to be 0.01% or less based on the weight of the flux.

Chromium (Cr) is an element added to stainless steels and welding materials so as to improve high-temperature corrosion resistance and high-temperature strength and stabilize austenite. If the sheath of the exemplary embodiment is an Fe—Ni-based alloy sheath, the content of chromium (Cr) may preferably be 20% or greater. However, if the content of chromium (Cr) is greater than 80%, it is difficult to add other basic components such as carbon (C), manganese (Mn), silicon (Si), and TiO₂ to the flux, and thus a flux-cored wire for all-position welding may not be provided. Therefore, preferably, the content of chromium (Cr) is adjusted to be 80% or less.

Molybdenum (Mo) is added in an amount of 0.1% or greater so as to improve high-temperature strength and oxidation resistance. However, if the content of molybdenum (Mo) is greater than 8.0%, ductility may decrease, and wire breakage may frequently occur due to an excessive filling amount when the welding material is produced in the form of a wire. Therefore, it may be preferable that the content of molybdenum (Mo) be 8.0% or less.

TiO₂ is added to the flux to guarantee arc stability and slag formation. If the content of TiO₂ is less than 7%, arc stability is not guaranteed. Particularly, slag may be formed in amounts which are too small, and thus weld beads may not be completely covered with the slag and may thus have rough surfaces. Conversely, if the content of TiO₂ is greater than 25%, the addition of basic alloying elements such as carbon (C), chromium (Cr), silicon (Si), and manganese (Mn) to the inside of a sheath strip is limited, and weldability may decrease due to an excessive amount of slag. Therefore, it may be preferable that the content of TiO₂ be within the range of 25% or less.

SiO₂ added to the flux increases the viscosity of slag. However, if the content of SiO₂ is less than 2%, SiO₂ has an insignificant viscosity increasing effect on the welding material including TiO₂ as the main component of slag. Conversely, if the content of SiO₂ is greater than 10%, the viscosity of slag may increase excessively, thereby increasing defects such as residual inclusions and the possibility of cracking due to a high silicon content in a metal deposit. Thus, it may be preferable that the content of SiO₂ be within the range of 10% or less.

ZrO₂ has a high melting point and thus increases the melting point of slag when added to the flux. To this end, the content of ZrO₂ is preferably 1% or greater. However, if the content of ZrO₂ is greater than 10%, non-molten sparks are generated around an arc. Thus, it may be preferable that the upper limit of the content of ZrO₂ be 10%.

In addition, the flux may further include at least one selected from the group consisting of nickel (Ni): 8% or less, copper (Cu): 8% or less, aluminum (Al): 3.5% or less, magnesium (Mg): 2.5% or less, titanium (Ti): 3.0% or less, and F: 8.0% or less.

Nickel (Ni) added to a heat resistant alloy stabilizes austenite and improves high-temperature corrosion resistance, high-temperature strength, and ductility. Although nickel (Ni) is basically added to the sheath formed of an Fe—Ni-based alloy, nickel (Ni) may also be added to the flux to additionally improve high-temperature corrosion resistance, high-temperature strength, and ductility. However, when the addition of other components is considered, it may be preferable that the content of nickel (Ni) be 8% or less.

Although copper (Cu) may be added to guarantee high-temperature oxidation resistance and improve the solubility of carbon (C), the content of copper (Cu) may preferably be adjusted to be 8% or less.

Aluminum (Al) and magnesium (Mg) may be added for deoxidation, desulfurization, and microstructure refinement of welding metal. However, if the content of aluminum (Al) is greater than 3.5% and the content of magnesium (Mg) is greater than 2.5%, the surface tension of molten flux metal increases, and thus spatters are excessively generated. Therefore, it may be preferable that the content of aluminum (Al) be 3.5% or less and the content of magnesium (Mg) be 2.5% or less.

Titanium (Ti) may be added to ensure arc stability and prevent grain boundary corrosion. However, if titanium (Ti) is excessively added, carbides or nitrides are formed in a weld zone, and thus ductility decreases. Therefore, it may be preferable that the content of titanium (Ti) be within the range of 3.0% or less.

Fluorine (F) is added to the flux in various forms such as CaF₂ or AlF₆ so as to improve the spreadability of weld slag. If the content of fluorine (F) in the flux is greater than 8.0%, the fluidity of slag may excessively increase, making it difficult to perform an all-position welding process and worsening the shape of weld beads. Therefore, it may be preferable that the content of fluorine (F) be 2.0% or less.

In addition, the flux may further include at least one selected from the group consisting of Na₂O: 2.5% or less, K₂O: 4.0% or less, Al₂O₃: 4.0% or less, MnO: 4.0% or less, and MgO: 4.0% or less.

Na₂O and K₂O are added to the flux as alkali components easily undergoing ionization and improving the fluidity of slag. However, if the content of Na₂O is greater than 2.5% and the content of K₂O is greater than 4.0%, weld fumes are excessively generated. Thus, preferably, the content of Na₂O may be adjusted to be 2.5% or less, and the content of K₂O may be adjusted to be 4.0% or less.

Al₂O₃ and MgO increase the viscosity of slag, and MnO decreases the viscosity of slag. That is, these components are added to the flux for controlling the viscosity of slag, leading to the formation of high-quality beads, and protecting a weld pool. When considering low specific gravities of Al₂O₃, MnO, and MgO, it may be preferable that each of the contents of Al₂O₃, MnO, and MgO be 4.0% or less.

Preferably, the flux may be present in an amount of 15% to 40%. The filling ratio of the flux may be determined according to the size of a filling space and the composition of the flux which are dependent on the composition, thickness, and width of the sheath. If the filling amount of the flux is less than 15%, the amount of flux may not be sufficient for providing the welding material as a flux-cored wire for all-position welding. Conversely, if the filling ratio of the flux is greater than 40%, breakage may frequently occur due to a metal sheath being too thin during a drawing process of flux-cored wire manufacturing processes, and thus the manufacturing processes may not be normally performed. Therefore, it may be preferable that the filling ratio of the flux to within the range of 15% to 40%.

### MODE FOR INVENTION

Hereinafter, examples of the present disclosure will be described in detail. The following example is for illustrative purposes and is not intended to limit the scope of the present disclosure.

### EXAMPLES

Welding materials having the compositions illustrated in Tables 1 and 2 were manufactured (in Tables 1 and 2, the content of each component is in wt %, and the balance is iron (Fe) and inevitable impurities). A welding process was performed on a base metal by a welding method illustrated in Table 3 using the welding materials. Thereafter, cracks, bead coverage, and defects except for cracks were observed in weld zones, and results thereof are illustrated in Table 4.

After the welding process, ceramic tape and slag were removed, and brushing was performed. It was determined whether high-temperature cracks were formed by observing cracks in initial-layer beads through a penetration test (PT). While checking high-temperature cracks, welding was completed, and then cracks and other defects were checked by a radiographic test (RT).

TABLE 1

| No. | C | Mn | Si | P | S | Ni | Cr | Mo | Cu | Al | Mg | Ti |
|---|---|---|---|---|---|---|---|---|---|---|---|---|
| RS 1 | 0.17 | 1.65 | 0.62 | 0.02 | 0.01 | 21.1 | 24.6 | 0.08 | 0.03 | 0.01 | 0 | 0 |
| RS 2 | 0.18 | 2.4 | 0.8 | 0.03 | 0 | 21.6 | 25.3 | 0.05 | 0.01 | 0.01 | 0.01 | 0 |
| RS 3 | 0.18 | 2 | 0.5 | 0.02 | 0 | 20.4 | 25.3 | 0.05 | 0.01 | 0.02 | 0.01 | 0.03 |
| CS 1 | 0.08 | 1.5 | 1.4 | 0.03 | 0.01 | 24 | 24.3 | 0.05 | 0.01 | 0.02 | 0.01 | 0.03 |
| CS 2 | 0.31 | 1.88 | 0.8 | 0.03 | 0.01 | 17.3 | 24.2 | 0.02 | 0.02 | 0.05 | 0 | 0 |
| CS 3 | 0.12 | 1.45 | 0.1 | 0.02 | 0 | 22 | 22.7 | 0.5 | 0.01 | 0.01 | 0 | 0 |
| CS 4 | 0.04 | 1.42 | 0.59 | 0.02 | 0 | 20.9 | 22.7 | 0.05 | 0 | 0.02 | 0 | 0 |
| CS 5 | 0.11 | 1.42 | 0.59 | 0.02 | 0.01 | 20.8 | 18.3 | 0.05 | 0 | 0 | 0 | 0 |
| CS 6 | 0.11 | 1.4 | 0.7 | 0.02 | 0.01 | 23.1 | 24.6 | 1.75 | 0 | 0.02 | 0 | 0 |
| CS 7 | 0.11 | 1.42 | 0.59 | 0.02 | 0.01 | 20.8 | 23.1 | 1.75 | 0 | 0 | 0 | 0 |
| CS 8 | 0.11 | 1.8 | 0.5 | 0.03 | 0 | 20.8 | 22 | 1.75 | 0 | 0 | 0 | 0 |
| IS 1 | 0.14 | 2 | 0.6 | 0 | 0 | 21 | 25 | 0 | 0.02 | 0.1 | 0.01 | 0.07 |
| IS 2 | 0.14 | 2 | 0.6 | 0.01 | 0 | 21 | 25 | 0 | 0.02 | 0.1 | 0.01 | 0.07 |
| CS 9 | 0.13 | 2 | 0.6 | 0.02 | 0 | 21 | 25 | 0 | 0.02 | 0.1 | 0.01 | 0.07 |
| IS 3 | 0.13 | 2 | 0.6 | 0 | 0.01 | 21 | 25 | 0 | 0.02 | 0.1 | 0.01 | 0.07 |
| CS 10 | 0.14 | 1.4 | 2.2 | 0 | 0.01 | 21 | 25 | 0 | 0.02 | 0.1 | 0.01 | 0.07 |
| IS 4 | 0.1 | 2 | 0.6 | 0 | 0 | 26 | 18 | 0.2 | 0.1 | 0.1 | 0.01 | 0.07 |
| CS 11 | 0.5 | 2 | 0.6 | 0 | 0.01 | 21 | 27 | 0 | 0.02 | 0.1 | 0.01 | 0.07 |
| IS 5 | 0.14 | 2 | 0.6 | 0 | 0 | 25 | 30 | 0 | 0.02 | 0.1 | 0.01 | 0.07 |
| IS 6 | 0.06 | 2.6 | 0.6 | 0 | 0 | 33 | 20 | 0 | 0.02 | 0.1 | 0.01 | 0.07 |

RS: Related-art Sample,
CS: Comparative Sample,
IS: Inventive Sample

TABLE 2

| No. | F | TiO₂ | SiO₂ | Na₂O | K₂O | Al₂O₃ | MnO | MgO | ZrO₂ | Sheath |
|---|---|---|---|---|---|---|---|---|---|---|
| RS 1 | 0.14 | 6.6 | 0.65 | 0.2 | 0.1 | 0.01 | 0.02 | 0 | 0.5 | 304 L |
| RS 2 | 0.2 | 4.55 | 1.4 | 0.3 | 0.2 | 0.05 | 0.4 | 0.05 | 0.05 | 304 L |
| RS 3 | 0.18 | 4.76 | 1.12 | 0.3 | 0.2 | 0.05 | 0.4 | 0 | 0.05 | 304 L |
| CS 1 | 0.18 | 0.94 | 0.12 | 0.08 | 0.01 | 0 | 0 | 0 | 0.05 | 304 L |
| CS 2 | 0.3 | 5.2 | 0.2 | 0.24 | 0.01 | 0 | 0 | 0.04 | 1.2 | 304 L |
| CS 3 | 0.08 | 3.9 | 0.15 | 0.08 | 0 | 0.02 | 0 | 0.01 | 0.55 | 304 L |
| CS 4 | 0.05 | 1.1 | 0.2 | 0.05 | 0.05 | 0 | 0 | 0.5 | 0.6 | 304 L |
| CS 5 | 0.05 | 1.25 | 3 | 0 | 0 | 0.05 | 0 | 0.01 | 0.6 | 304 L |
| CS 6 | 0.05 | 1.1 | 1 | 0.05 | 0.05 | 0 | 0.05 | 0.5 | 0 | 316 L |
| CS 7 | 0.05 | 3.2 | 0.8 | 0.05 | 0 | 0 | 0 | 0.01 | 0.75 | 316 L |
| CS 8 | 0.05 | 1.5 | 0.8 | 0.05 | 0 | 0 | 0 | 0.01 | 3.5 | 316 L |
| IS 1 | 0.24 | 5 | 0.26 | 0.12 | 0 | 0 | 0.1 | 0 | 1.05 | 35% Ni—Fe |
| IS 2 | 0.24 | 5.4 | 0.26 | 0.12 | 0 | 0 | 0.1 | 0 | 1.05 | 35% Ni—Fe |
| CS 9 | 0.24 | 5.1 | 0.26 | 0.12 | 0 | 0 | 0.1 | 0 | 1.05 | 35% Ni—Fe |
| IS 3 | 0.24 | 5.1 | 0.26 | 0.12 | 0 | 0 | 0.1 | 0 | 1.05 | 35% Ni—Fe |
| CS 10 | 0.24 | 5 | 0.26 | 0.12 | 0 | 0 | 0.1 | 0 | 1.05 | 35% Ni—Fe |
| IS 4 | 0.24 | 5 | 0.26 | 0.12 | 0 | 0 | 0.1 | 0 | 1.05 | 35% Ni—Fe |
| CS 11 | 0.24 | 1.2 | 0.26 | 0.12 | 0 | 0 | 0.1 | 0 | 1.05 | 42% Ni—Fe |
| IS 5 | 0.24 | 3.6 | 0.26 | 0.12 | 0 | 0 | 0.1 | 0 | 1.05 | 42% Ni—Fe |
| IS 6 | 0.24 | 3.6 | 0.26 | 0.12 | 0 | 0 | 0.1 | 0 | 1.05 | 42% Ni—Fe |

RS: Related-art Sample,
CS: Comparative Sample,
IS: Inventive Sample

TABLE 3

| | Base | | | | Test | | | | |
|---|---|---|---|---|---|---|---|---|---|
| Base | metal size | | Root | Welding | conditions | Welding | Shielding | | End |
| metal | (mm) | Beveling | Gap | position | (A/V) | method | gas | Fixing | tab |
| STS | 200 L* | 45° | 8 mm | FALT | 190/32 | Auto- | C0₂ 100% | Bolt | Used |
| 310S | 150 W* | One side | | | | carriage | | type | |
| | 30 t | | | | | | | jigs | |

TABLE 4

| No. | Cracking | bead coverage | Defects except for cracks |
|---|---|---|---|
| RS 1 | ∘ | ∘ | x |
| RS 2 | ∘ | ∘ | x |
| RS 3 | ∘ | ∘ | x |
| CS 1 | ∘ | x | x |
| CS 2 | ∘ | ∘ | x |
| CS 3 | ∘ | ∘ | x |
| CS 4 | ∘ | x | ◯ (inclusions) |
| CS 5 | ∘ | ∘ | x |
| CS 6 | ∘ | ∘ | x |
| CS 7 | ∘ | ∘ | x |
| CS 8 | ∘ | x | x |
| IS 1 | x | ∘ | x |
| IS 2 | x | ∘ | x |
| CS 9 | ∘ | ∘ | x |
| IS 3 | x | ∘ | x |
| CS 10 | ∘ | ∘ | x |
| IS 4 | x | ∘ | x |
| CS 11 | x | x | ◯ (inclusions) |
| IS 5 | x | ∘ | x |
| IS 6 | x | ∘ | x |

RS: Related-art Sample, CS: Comparative Sample, IS: Inventive Sample
Cracking: ∘ occurred, x did not occur
bead coverage: ∘ good, x poor
Defects except for cracks: ∘ defective, x no defect

As illustrated in Table 4, in the case of welding materials satisfying conditions of the present disclosure, cracks and other defects were not observed, and high-quality beads were formed. That is, the welding materials had a high degree of weldability.

However, in the case of related-art samples and Comparative Samples 1 to 8 including sheaths formed of conventional 300-series steels, cracks were observed in weld zones. In the case of Comparative Samples 9, 10, and 11 including sheaths formed of high Ni—Fe alloys but not satisfying the composition proposed in the present disclosure, cracks were observed in weld zones, or poor bead coverage or other defects were observed.

1. A welding material for heat resistant steel, the welding material comprising flux and a sheath surrounding the flux,
wherein the welding material comprises, by wt %, carbon (C): 0.03% to 0.3%, manganese (Mn): 0.5% to 3.0%, silicon (Si): 0.1% to 2.0%, phosphorus (P): 0.01% or less, sulfur (S): 0.01% or less, nickel (Ni): 20% to 40%, chromium (Cr): 15% to 35%, TiO₂: 3% to 7%, SiO₂: 0.5% to 2.5%, ZrO₂: 0.5% to 2.5%, and a balance of Fe and inevitable impurities,
wherein the sheath comprises an Ni—Fe-based alloy having a nickel content of 30% to 50%.

2. The welding material of claim 1, wherein a total content of phosphorus (P) and sulfur (S) in the welding material is 0.012% or less.

3. The welding material of claim 1, wherein the welding material further comprises at least one selected from the group consisting of molybdenum (Mo): 2.0% or less, copper (Cu): 1.0% or less, aluminum (Al): 0.5% or less, and magnesium (Mg): 0.5% or less.

4. The welding material of claim 1, wherein the welding material further comprises at least one selected from the group consisting of titanium (Ti): 0.5% or less, fluorine (F): 0.5% or less, Na₂O: 0.25% or less, K₂O: 0.3% or less, Al₂O₃: 0.5% or less, MnO: 0.5% or less, and MgO: 0.5% or less.

5. The welding material of claim 1, wherein the Ni—Fe-based alloy is an invar alloy.

6. The welding material of claim 1, wherein the flux comprises, by wt %, carbon (C): 0.1% to 2.0%, manganese (Mn): 2.0% to 10.0%, silicon (Si): 0.5% to 8.0%, phosphorus (P): 0.01% or less, sulfur (S): 0.01% or less, chromium (Cr): 40% to 80%, molybdenum (Mo): 0.1% to 8.0%, TiO₂: 7% to 25%, SiO₂: 2% to 10%, ZrO₂: 1% to 10%, and a balance of iron (Fe) and inevitable impurities.

7. The welding material of claim 6, wherein a total content of phosphorus (P) and sulfur (S) in the flux is 0.01% or less.

8. The welding material of claim 6, wherein the flux further comprises at least one selected from the group consisting of nickel (Ni): 8% or less, copper (Cu): 8% or less, aluminum (Al): 3.5% or less, magnesium (Mg): 2.5% or less, titanium (Ti): 3.0% or less, and fluorine (F): 8.0% or less.

9. The welding material of claim 6, wherein the flux further comprises at least one selected from the group consisting of Na₂O: 2.5% or less, K₂O: 4.0% or less, Al₂O₃: 4.0% or less, MnO: 4.0% or less, and MgO: 4.0% or less.

10. The welding material of claim 1, wherein the filling ratio of the flux is 15% to 40%.
